(19) United States
(12) Patent Application Publication
(10) Pub. No.: US 2025/0047701 A1
(43) Pub. Date: Feb. 6, 2025

(54) ASSET SECURITY AND RISK POSTURE VISUALIZATION

(71) Applicant: Palo Alto Networks, Inc., Santa Clara, CA (US)

(72) Inventors: Kalyan Siddam, San Jose, CA (US); Daniel Pare, Oakland, CA (US); Yue Jiang, San Jose, CA (US); Jun Wang, San Jose, CA (US); Ling Zeng, Sunnyvale, CA (US); Vu Pham, San Jose, CA (US); Ran Xia, San Jose, CA (US)

(21) Appl. No.: 18/228,397

(22) Filed: Jul. 31, 2023

(51) Int. Cl. H04L 9/40; G06F 8/65; H04L 41/12

(52) U.S. Cl. CPC H04L 63/1433; G06F 8/65; H04L 41/12

(57) ABSTRACT

A system, method, and device for visualizing network topology are disclosed. The method includes (i) automatically generating a network topology visualization of network assets for a network, and (ii) grouping the network assets into a plurality of groupings based on a set of user selected distinct criteria.

### BACKGROUND OF THE INVENTION

Computer networks have become increasingly complex, with numerous interconnected devices and systems spanning vast geographical areas. Visualizing network topology is crucial for administrators, engineers, and operators to understand the structure and relationships between various network elements. Traditional methods of network visualization, such as network diagrams and tabular representations, often fall short in adequately conveying the intricate nature of modern network environments.

Existing network visualization tools typically offer limited functionalities and lack the ability to scale and adapt to evolving network architectures. These tools often suffer from poor user experience, presenting dense and cluttered visualizations that are difficult to interpret. Consequently, network administrators and operators face challenges in identifying bottlenecks, detecting anomalies, identifying security risks, and optimizing network performance.

### BRIEF DESCRIPTION OF THE DRAWINGS

Various embodiments of the invention are disclosed in the following detailed description and the accompanying drawings.

FIG. 1 is a block diagram of a system of network assets according to various embodiments.

FIG. 2 is a block diagram of a system for generating network topology visualizations according to various embodiments.

FIG. 3 is an example of a visualization definition user interface according to various embodiments.

FIG. 4 is an example of a network topology visualization according to various embodiments.

FIG. 5 is an example of a network topology visualization according to various embodiments.

FIG. 6 is an example of a network topology visualization according to various embodiments.

FIG. 7 is an example of a network topology visualization according to various embodiments.

FIG. 8 is an example of a network topology visualization according to various embodiments.

FIG. 9 is an example of a network topology visualization according to various embodiments.

FIG. 10 is an example of a network topology visualization according to various embodiments.

FIG. 11 is an example of a network topology visualization according to various embodiments.

FIG. 12 is a flow diagram of a method for providing a network topology visualization for a data abstraction according to various embodiments.

FIG. 13 is a flow diagram of a method for generating a network topology visualization according to various embodiments.

FIG. 14 is a flow diagram of a method for updating a network topology visualization according to various embodiments.

FIG. 15 is a flow diagram of a method for identifying security risks in a network topology according to various embodiments.

FIG. 16 is a flow diagram of a method for identifying security risks in a network topology according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a network asset may include various physical and/or logical devices that communicate with, connect to, or are part of, the network. Examples of network assets include routers, switches, firewalls, mobile phones, laptops, computers, servers, datastores, smart devices, switch ports, network peers, a virtual local area network (VLAN), and firewall zones, etc. Various other network assets may be implemented.

A general impetus for network topology visualization is the principle that one cannot protect what it cannot see. Visibility is a functional cybersecurity strategy to protect network assets and information, which can be broadly applied to securing Internet of Things (IoT) assets, Manufacturing Internet of Things (IoT) assets, Operational Technology (OT) assets, and Information Technology (IT) assets. Visibility assists security professionals, network professionals, and asset owners, or other parties looking to understand network connected assets on-premises and/or in the cloud.

Various embodiments visualize network assets, the network asset behaviors, and groups the network assets on case-driven criteria to drive insights. The case-driven criteria may be user defined. For example, various embodiments provide an intuitive user interface via which a user defines one or more of a criteria scope (e.g., a scope of the environment or network assets to be visualized), a grouping criteria, and/or a visualization type. The system generates a corresponding network topology, which may include highlighting the network asset security postures, vulnerabilities to the network, information, or network assets, etc. The system collects (e.g., discovers) information pertaining to network assets (e.g., subnet, vendor, device type, communication paths, identifies of other network assets with which it communicates, etc.) and identifies (e.g., detects) anomalies or security threats posed by the network asset.

The system utilizes a combination of data gathering modules and visualization engines to create an interactive and dynamic representation of the network topology. The data gathering modules collect information about the network assets, including routers, switches, servers, and links, while the visualization engines process this data and generate comprehensive graphical representations.

The visualization output is presented through an intuitive user interface, offering users the ability to explore the network topology at various levels of granularity. Users can navigate and interact with the visualized network, zooming in and out, filtering specific elements, and accessing detailed information about each component. The system also provides real-time updates, ensuring that the visual representation accurately reflects the current state of the network.

Various embodiments implement advanced visualization techniques, such as hierarchical layouts, clustering algorithms, and color-coded indicators, to emphasize important aspects of the network topology, detected security threats, etc. Additionally, the system includes features for anomaly detection, performance monitoring, and the ability to overlay additional data, such as traffic patterns or security events, onto the visual representation.

The system may include a security analysis module that evaluates the security posture of network assets based on predefined security criteria. These criteria can include factors such as vulnerability assessments, compliance standards, access control policies, historical security events, communication patterns or identities of other network assets with which a particular network asset communicates, a device management status, etc. The security analysis module assesses the security attributes of each network asset and determines its security risk level. The system may automatically determine an active measure recommendation for a recommended active measure to be implemented to remediate an identified security risk. The system may automatically implement the active measure or may provide the active measure recommendation to a user, such as via a prompt on a user interface comprising the generated network topology visualization or linked from the network topology visualization (e.g., the user navigates to the interface providing the active measure recommendation from selecting a link on the interface providing the network topology visualization.

The system incorporates a grouping module that allows users to define and apply specific criteria to group network assets (e.g., to identify a grouping(s) to be applied to generate the network topology visualization). Examples of grouping criteria can include factors such as Purdue level, subnet, VLAN identifier, device category, device profile, vendor, risk level, location, function, security level, or any other user-defined attribute. Various other grouping criteria may be implemented. The grouping module analyzes the network infrastructure and assigns assets to the appropriate groups based on the specified criteria. In some embodiments, the system receives a plurality of user-defined grouping criteria, and generates the network topology visualization based at least in part on the plurality of user-defined grouping criteria. For example, the user specifies a primary grouping criteria and a secondary grouping criteria, and the system groups the network assets first by the primary grouping criteria and subsequently by the secondary grouping criteria.

Once the network assets are grouped, the visualization engines dynamically update the visual representation of the network topology to reflect the new grouping structure. This dynamic visualization provides users with the ability to view the network from different perspectives, focusing on specific groups of assets as defined by the user-specified criteria. The system employs visual cues, such as color coding or highlighting, to differentiate and emphasize the grouped elements within the overall network topology visualization or to identify certain properties of network assets, such as potential security risks, future network configurations, physical network topology, etc. The visual cues may be configured based on user-defined visualization parameters. For example, the user defines criteria for emphatic display of a subset of network assets or corresponding information.

Users can interact with the visualization interface to explore the security posture of different asset groups, drill down into specific groups, or switch between various grouping criteria and security risk levels. The system ensures that the visual representation accurately reflects the current security posture of the network assets, offering real-time updates as new security assessments are performed or as assets are added, removed, or reclassified. The user can zoom into certain elements of the network topology to obtain different or more-detailed information pertaining to the network assets or network topology. Additionally, or alternatively, the user can select a particular network asset within the network topology and in response to the user selection, the system provides an interface providing detailed information for the particular network asset.

The optional embodiment of security posture analysis based on the grouping of network assets enhances the system's functionality by providing users with valuable insights into the security vulnerabilities and risks within their network infrastructure. Administrators and operators can prioritize their security efforts, allocate resources effectively, and take proactive measures to mitigate potential threats. By combining security analysis with dynamic visualization, the system empowers users to make informed decisions and respond swiftly to emerging security challenges.

Various embodiments provide a system, method, and device for visualizing network topology. The method includes (i) automatically generating a network topology visualization of network assets for a network, and (ii) grouping the network assets into a plurality of groupings based on a set of user selected distinct criteria.

Various embodiments improve on related art visualization techniques by providing a flexible criteria scope for focusing on network assets of interest, flexible grouping of network assets, identification (e.g., emphatic display of) security risks/issues or attributes of interest (e.g., to identify/locate a network asset in the network topology that would otherwise be a needle in the haystack), context-based identification of networks or network assets, etc. Related art visualization techniques do not allow a user to create a visualization matching specific criteria scope. Further related art visualization techniques do not provide the ability for a user to group network assets, or to highlight (e.g., emphatically display) particular network assets based on user-defined criteria.

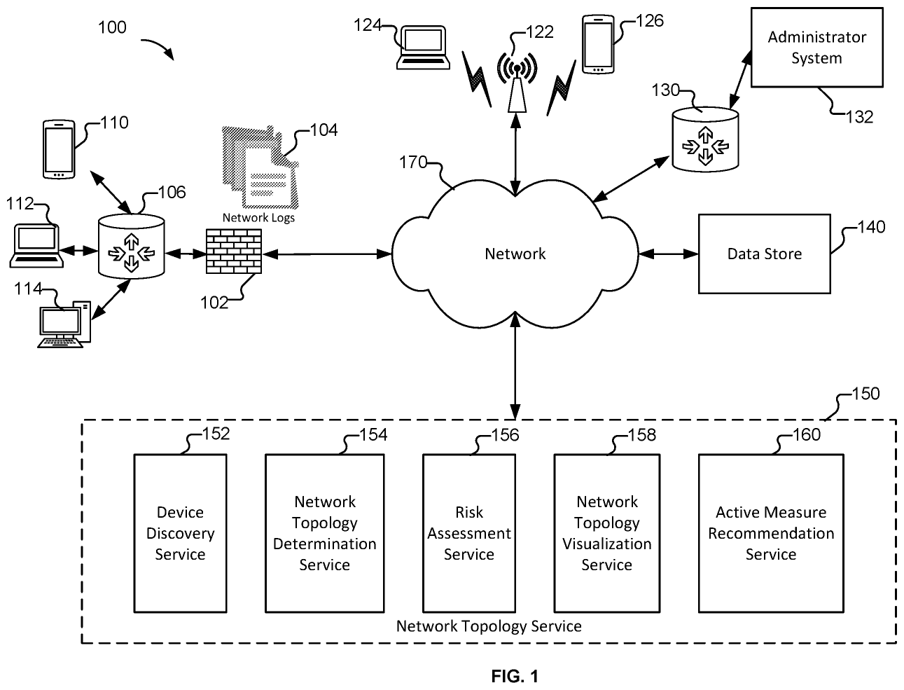

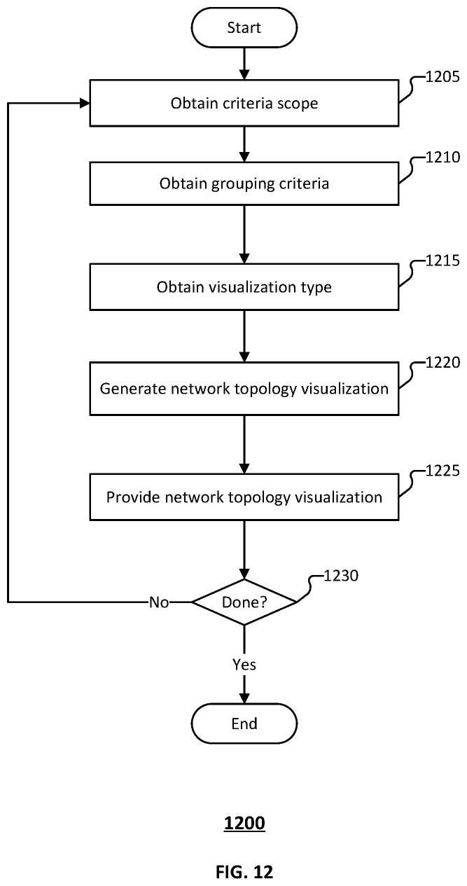

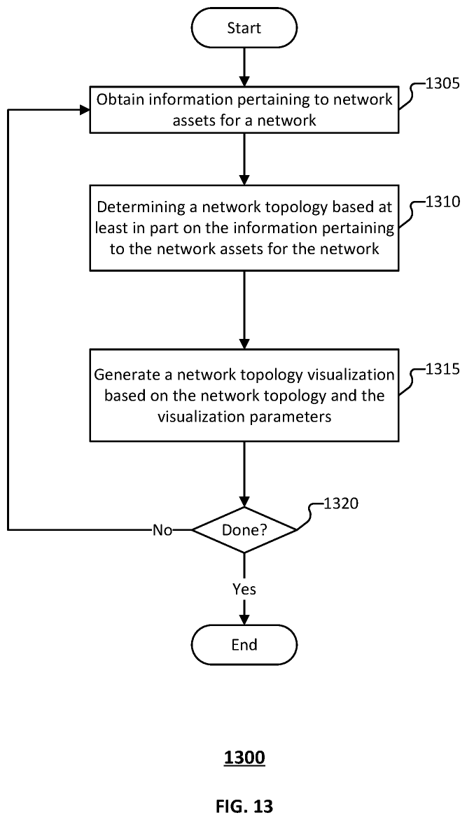

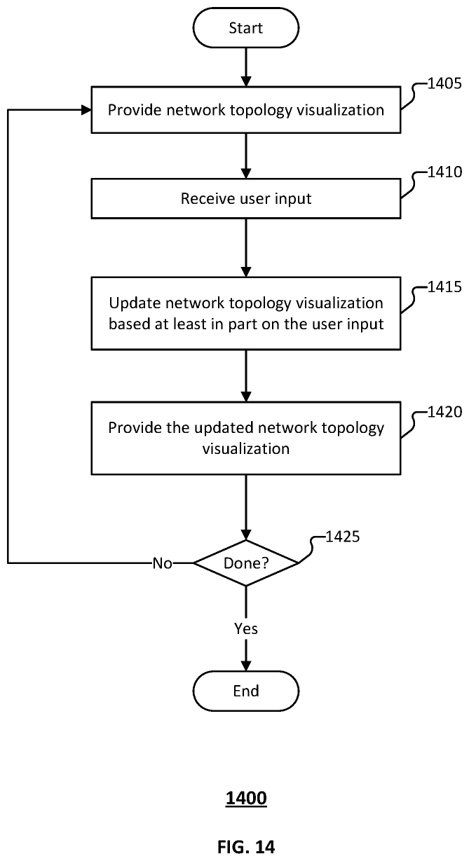

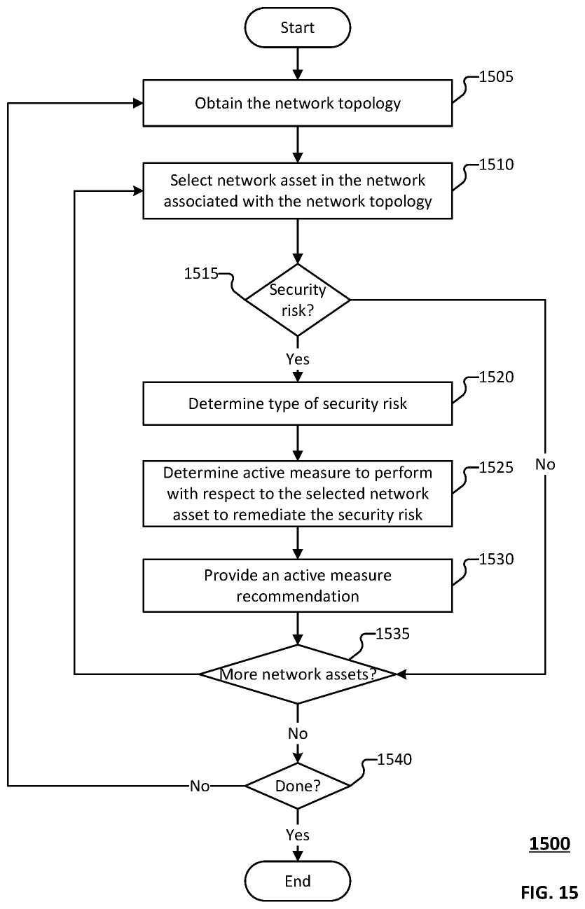

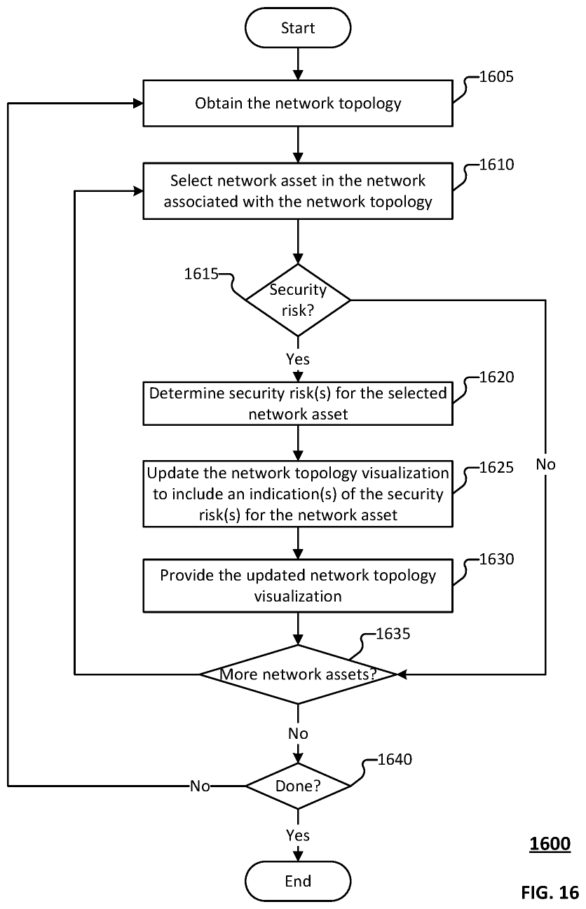

FIG. 1 is a block diagram of a system of network assets according to various embodiments. In some embodiments, system 100 implements at least part of process 1200 of FIG. 12, process 13 of FIG. 13, process 14 of FIG. 14, process 1500 of FIG. 15, and/or process 1600 of FIG. 16.

In the example shown, system 100 generates network topology visualizations for a network comprising a plurality of network assets. The network topology visualizations may be customized, such as based on user-definition. The user-definition can include one or more of a criteria scope (e.g., a scope of the environment or network assets to be visualized), a grouping criteria, and/or a visualization type. In some embodiments, system 100 comprises network topology service 150, which may be implemented by one or more systems, servers, or clusters of virtual machines. System 100 uses network topology service 150 to generate the network topology visualization for the network assets of network 170.

As illustrated in FIG. 1, system 100 comprises a plurality of network assets, including firewall 102, router 106, mobile phone 110, laptop 112, computer system 114, wireless access point 122, laptop 124, mobile phone 126, router 130, administrator system 132 (e.g., a computer system), data store 140, etc.

In connection with determining a network topology and/or generating a network topology visualization, system 100 performs device discovery. Device discovery, particularly discovery of IoT devices, is described in U.S. Patent Application Publication No. 2022/0095092, the entirety of which is hereby incorporated herein for all purposes. Device discovery may be performed actively, passively, or a combination of active and passive discovery techniques. System 100 uses network topology service 150 to perform device discovery to determine the various network assets that communicate with, connect to, or are part of, network 170. For example, network topology service 150 comprises device discovery service 152 that is invoked to perform the device discovery.

In some embodiments, device discovery service 152 performs device discovery by obtaining and analyzing network logs (e.g., traffic logs) that may be maintained by various network assets. In the example shown, firewall 102 maintains network logs 104, which stores data pertaining to network traffic between router 106 and network 170. Various other network assets may store network logs. Device discovery service 152 can query the network assets for the network logs and use the network logs to determine a network topology and information indicating communications between network assets, etc.

In some embodiments, device discovery service 152 uses machine learning techniques to analyze the collected network logs and to identify network assets and determine a network topology. As an example, device discovery service 152 implements a machine learning model to classify devices (e.g., device type, make, model, vendor, etc.) and to identify metadata associated with the devices.

In some embodiments, device discovery service 152 is integrated with another service or system, such as a third-party system. As an example, device discovery service 152 is integrated or connected to an asset management system, and device discovery service 152 can obtain information pertaining to network assets managed by the asset management system. The information obtained from other services or systems can be used to supplement the information obtained from the network logs.

Additionally, or alternatively, in various embodiments device discovery service 152 polls devices (e.g., network assets) for supplemental information. The polling of devices may be used in conjunction with analysis of network logs to supplement the information in the network logs.

Additionally, or alternatively, in various embodiments device discovery service 152 performs a crawling of the network structure. Device discovery service 152 can leverage third party integrations to obtain information pertaining to devices/network assets and/or perform an SNMP crawl to obtain further information about devices and network topology (e.g., including an identification of switches and a set of devices connected to the respective switches). Device discovery service 152 can also obtain further information pertaining to devices/network assets based on selective polling, where a predefined protocol is used to poll a device to obtain additional data about the device/network asset.

After the network assets are discovered (e.g., after performing device discovery), network topology service 150 uses network topology determination service 154 to determine a network topology. Network topology determination service 154 uses the information obtained during device discovery to map the network topology. For example, network topology determination service 154 uses the device discovery information to determine connections between network assets or behavior of the network assets and/or network 170. Network topology determination service 154 may store a current network topology state and/or a future network topology state. For example, network topology determination service 154 can perform a simulation (e.g., based on user-defined simulation criteria) to assess a future network topology state and/or a manner in which the behavior of the network assets is changed. An example of a simulation is the configuration or placement of a new firewall or removal of an existing firewall in order to assess how the behavior of network 170 or certain network assets correspondingly changes. The mapping of a current network topology state and a future network topology state enables system 100 to determine what would happen if the simulated changes were made to the network environment.

System 100 uses network topology service 150 to analyze network 170 and assess a security posture of network 170 and/or the network assets comprised in system 100. For example, network topology service 150 comprises risk assessment service 156 that is configured to determine a security posture of the network 170 and/or a set of network assets (or a particular network asset). Conventional techniques for determining security postures or for identifying security risks or anomalies may be implemented.

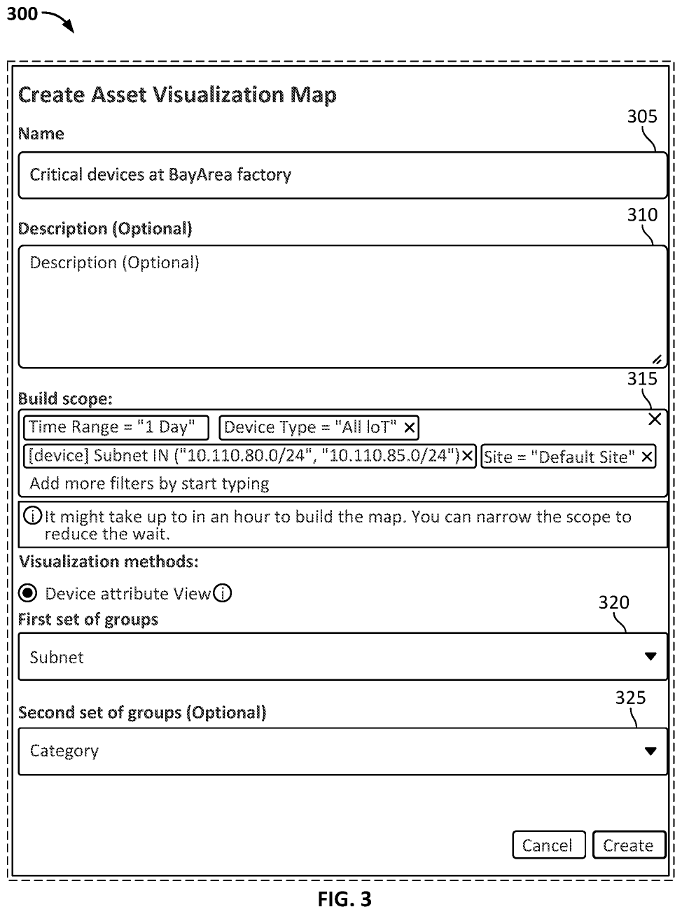

System 100 uses network topology service 150 to visualize the network topology. Network topology service 150 may comprise network topology visualization service 158, which is configured to generate a network topology visualization. The network topology visualization may be generated based on a user-defined criteria. In some embodiments, network topology visualization service 158 obtains parameters for the network topology visualization based at least in part on user input or preferences. For example, according to various embodiments network topology visualization service 158 configures and provides an intuitive user interface via which a user defines one or more of a criteria scope (e.g., a scope of the environment or network assets to be visualized), a grouping criteria, and/or a visualization type. Additionally, the user may define a criteria for highlighting or identifying network assets or certain characteristics of the network assets (e.g., the user may select to have mobile phones to be more emphatically displayed than other network assets). An example of the user interface via which a user defines the network topology visualization is user interface 300 of FIG. 3. Network topology visualization service 158 generates the network topology visualization based at least in part on the user-defined parameters and the network topology determined by network topology determination service 154.

In some embodiments, the user-defined parameters include a plurality of grouping criteria according to which the network assets are grouped. The network topology visualization is generated to include multi-level groupings, such as a grouping by vendor and then by risk. The plurality of grouping criteria may include a primary grouping criteria and a secondary grouping criteria. Network topology visualization service 158 generates the network topology visualization to include the grouping of network assets according to the plurality of grouping criteria. The network topology visualization may be configured to emphatically display certain features or network assets based at least in part on a predefined highlight criteria and/or a user-defined highlight criteria. For example, the user may define a highlight criteria to include emphatically displaying a particular device type, network assets for a particular subnet, network assets identified to be security risks, network assets determined to have a particular security risk level(s), etc. Various other criteria for highlighting or emphatically displaying certain features or network assets may be implemented.

According to various embodiments, the network topology visualization is configured to be interactive, such as based on user input. Interactive elements of the network topology visualization include (i) providing a zoom-in and zoom-out functionality to change the granularity with which the network topology visualization is displayed (e.g., to toggle among layers of network topology information), (ii) enabling user selection of a particular grouping or network asset to obtain more detailed information, (iii) enabling a user to select a network asset in a manner that is hyperlinked to another user interface that provides detailed information for the network asset and/or enables the user to control or configure the network asset (e.g., to perform an active measure with respect to the selected network asset to remediate an identified security risk). In response to receiving a user input corresponding to a request to zoom-in, network topology visualization service 158 updates the interface (e.g., the network topology visualization) to provide different or more specific information. For example, a user may select to zoom-in to a particular grouping or network asset and additional insights for the grouping or network asset are displayed.

According to various embodiments, the network topology visualization enables the user to (a) create a network asset visualization based on a specific criteria scope (e.g., site, asset type, network subnet, (b) group network assets based on one or more criteria (e.g., Group 1: network subnet or asset type; Group 2: vendor, risk level, or user tag), (c) select to view details of a selected object (e.g., a network asset or group of network assets, communication link or group of communication links between network assets), (d) select to zoom-in to a selected object (e.g., a selected network asset or group of network assets), (e) compare a current state versus a desired future state for proactive planning and elimination of expensive iterative changes, (f) highlight network assets and/or network communication behaviors matching specified criteria (e.g., critical security risks, applications, user tags, asset types, information types such as personal health information, personal identifiable information, payment card information data, etc.), and/or (g) implement predefined highlights to identify issues, save highlights, or save visualizations. In some embodiments, the network topology visualization enables the user to identify the internet addresses (e.g., URLs) with which a device is communicating. The system can flag certain internet endpoints as potentially malicious sites based on an assessment of the corresponding address.

In some embodiments, network topology visualization service 158 generates the network topology visualization based at least in part on (i) obtaining a specification for a criteria scope, (ii) obtaining a specification for a grouping criteria, (iii) obtaining a specification for a visualization type, (iv) visualize the network topology, (v) enable interaction with the network topology visualization to provide insights or plan a response, and (v) highlight elements of the network topology visualization, such as to provide additional insights or plan a response.

Network topology service 150 may further comprise active measure recommendation service 160. In some embodiments, active measure recommendation service 160 determines active measures or active measure recommendations based at least in part on the network posture or security posture (e.g., security posture of the network or a particular network asset(s)). Active measure recommendation service 160 may provide an active measure recommendation (e.g., via the network topology visualization or associated user interface) to a user. The active measure to be performed or recommended may be determined based at least in part on a security risk and/or other characteristics of the particular groups or network assets. For example, the active measure is determined based at least in part on a mapping of security risk types to active measures. Examples of active measures include prompting a user or administrator of a particular network asset or grouping of network assets to perform a certain action, installing a patch, re-configuring the network asset or grouping of network assets, installing a firewall to a particular location in network 170, isolating or quarantining a particular network asset or grouping of network assets, invoke a change of password for the network asset(s), etc.

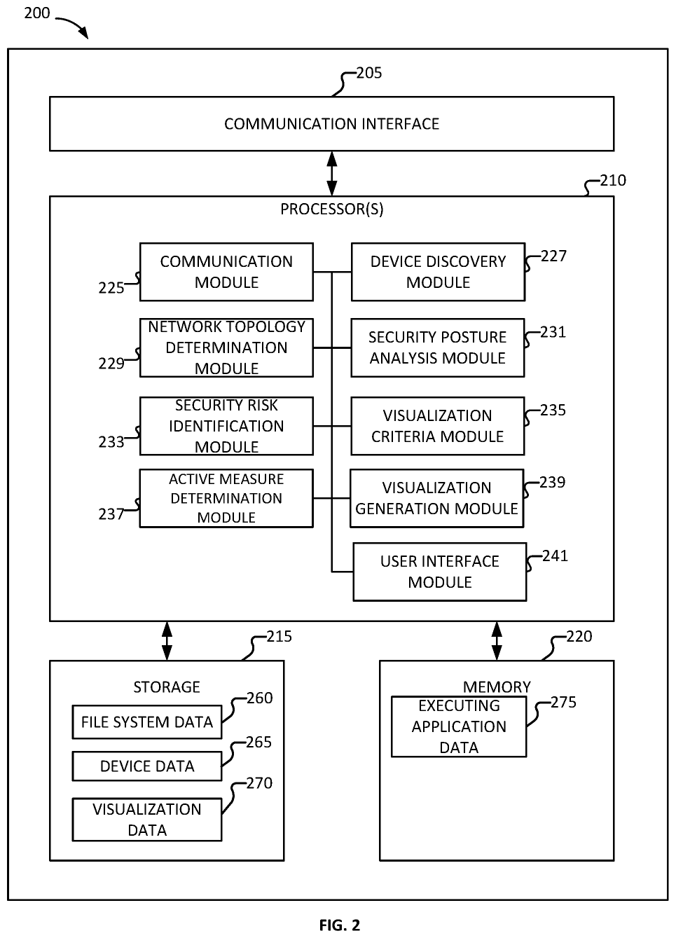

FIG. 2 is a block diagram of a system for generating network topology visualizations according to various embodiments. In some embodiments, system 200 implements at least part of process 1200 of FIG. 12, process 13 of FIG. 13, process 14 of FIG. 14, process 1500 of FIG. 15, and/or process 1600 of FIG. 16. In some embodiments, system 200 implements at least part of system 100. For example, system 200 implements network topology service 150 of system 100.

In the example shown, system 200 implements one or more modules in connection with generating and providing network topology visualizations, etc. System 200 comprises communication interface 205, one or more processors 210, storage 215, and/or memory 220. One or more processors 210 comprises one or more of communication module 225, device discovery module 227, network topology determination module 229, security posture analysis module 231, security risk identification module 233, visualization criteria module 235, active measure determination module 237, visualization generation module 239, and/or user interface module 241.

In some embodiments, system 200 comprises communication module 225. System 200 uses communication module 225 to communicate with various network assets, nodes or end points (e.g., client terminals, firewalls, DNS resolvers, data appliances, other security entities, etc.) or user systems such as an administrator system. For example, communication module 225 provides to communication interface 205 information that is to be communicated (e.g., to another node, security entity, etc.). As another example, communication interface 205 provides to communication module 225 information received by system 200. Communication module 225 is configured to receive a visualization definition/parameter(s) (e.g., criteria scope, grouping criteria, visualization types, highlight criteria, etc.), etc. Communication module 225 is further configured to receive one or more settings or configurations from an administrator. Examples of the one or more settings or configurations include configurations of a machine learning model (e.g., a model used to interpret the natural language query), configurations of a visualization, configuration of active measures (e.g., mappings of certain properties/characteristics to active measures), etc.

In some embodiments, system 200 comprises device discovery module 227. System 200 uses device discovery module 227 to discover network assets for a particular network. Device discovery module 227 may obtain network logs from various network assets, such as firewalls or routers and perform device discovery based at least in part on the network logs. Various other device discovery techniques may be implemented or used to supplement the use of network logs. Examples of other techniques include (i) using a machine learning model to analyze the network logs or other information pertaining to communication across the network to identify devices or determine characteristics for the devices, (ii) obtaining device information from various integrations such as an asset management system, (iii) crawling the network, and/or (iv) polling network assets for information.

In some embodiments, system 200 comprises network topology determination module 229. System 200 uses network topology determination module 229 to determine a network topology based at least in part on the discovered devices and associated information, such as the information obtained by device discovery module 227. Network topology determination module 229 may determine the network topology automatically (e.g., the system may generate/update the network topology according to a predefined time interval or in response to a certain event such as introduction of a new network asset, etc.) or in response to a request for a network topology visualization.

In some embodiments, system 200 comprises security posture analysis module 231. System 200 uses security posture analysis module 231 to determine a security posture of the network and/or the network assets for the network. Security posture analysis 231 may use the network topology in accordance with assessing the security posture. Additionally, or alternatively, security posture analysis module 231 uses information pertaining to the network assets to determine the security posture. In some embodiments, security posture analysis module 231 simulates a particular network configuration or device configuration and analyzes the changes (if any) to the security posture of the network or network assets.

In some embodiments, system 200 comprises security risk identification module 233. System 200 uses security risk identification module 233 to identify potential risks (e.g., security risks) based at least in part on the security posture. Security risk identification module 233 classifies the various risks (if any) that are present in the network. Security risk identification module may assign a security risk level to a particular security risk or set of risks.

In some embodiments, system 200 comprises visualization criteria module 235. System 200 visualization criteria module 235 to obtain a visualization criteria according to which the network topology visualization is to be generated. As an example, visualization criteria module 235 uses user interface module 241 to configure and present a user interface, such as user interface 300 of FIG. 3, to which a user specifies one or more visualization criteria. Examples of the visualization criteria include one or more of a criteria scope (e.g., a scope of the environment or network assets to be visualized), a grouping criteria, and/or a visualization type. The grouping criteria may include a definition of a multi-level grouping according to which the network assets are to be grouped when visualized. For example, the grouping criteria includes a plurality of user-defined grouping criteria (e.g., a primary grouping criteria and a secondary grouping criteria). According to various embodiments, at least a subset of the visualization criteria is user-defined. Various other visualization criteria may be predefined, such as in association with user or organization preferences or settings. Examples of visualization types include a bar chart visualization, a line chart visualization, a donut visualization, map visualization, a sunburst visualization, a pie chart visualization, a histogram visualization, a single value visualization, a parallel sets visualization, to a pie map visualization, a bubble map visualization, polar bar chart visualization, a scatter plot visualization, a table visualization, a hub-and-spoke visualization, etc. Various other types of visualizations and corresponding rules for the visualization types may be implemented.

In some embodiments, system 200 comprises active measure determination module 237. System 200 active measure determination module 237 to determine an active measure recommendation or an active measure to be implemented in connection with remediating an identified security risk or anomaly. Active measure determination module 237 determines the active measure based at least in part on the type of security risk or anomaly identified. For example, active measure determination module 237 performs a look up against a mapping of security risks or types of security risks to active measures. As another example, active measure determination module 237 performs a look up against a mapping of security risk levels to active measures. The mapping of security risks, security risk levels, or security risk types to active measures may be predefined, such as based on user or organization preferences.

In some embodiments, system 200 comprises visualization generation module 239. System 200 uses visualization generation module 239 to generate a visualization based at least in part on the visualization criteria and the network topology. For example, visualization generation module 239 groups the network assets according to the specified grouping criteria (e.g., the primary grouping and the secondary grouping) and generates a visualization according to a predefined or user-specified visualization type. In some embodiments, the network topology visualization includes a visual representation of the logical and physical connections between various network assets. Generating the network topology visualization includes configuring the network topology visualization to emphatically display one or more elements (e.g., network assets, connections, etc.) according to a predefined or user-specified criteria (e.g., a color-coding criteria, a highlight criteria, a bold criteria, etc.). The network topology visualization may visualize how a network topology appears in a physical world and/or how a network topology appears in a logical world.

In some embodiments, system 200 comprises user interface module 241. System 200 uses user interface module 241 to configure and provide a user interface to a user, such as to a client system used by the user. User interface module 241 configures a user interface to provide the visualization generated in response to the natural language query. Additionally, user interface module 241 may include various input fields or selectable elements with which a user can input user-defined criteria (e.g., grouping criteria, visualization type, scope criteria, etc.), or selection of certain elements to interface with network topology visualization. In some embodiments, user interface module 241 provides an interface via which a user may select among a plurality of network assets provided in the network topology visualization.

According to various embodiments, storage 215 comprises one or more of filesystem data 260, device data 265, and visualization data 270. Storage 215 comprises a shared storage (e.g., a network storage system) and/or database data, and/or user activity data.

In some embodiments, filesystem data 260 comprises a database such as one or more datasets (e.g., one or more datasets for network assets, network asset configurations, network configurations, etc.).

Device data 265 comprises information pertaining to one or more network assets associated with the network. Examples of information comprised in device data 265 includes make, model, operating system, IP address, unique device identifier(s), device type, vendor, installed applications, software versions, etc.

Visualization data 270 comprises information pertaining to one or more network topology visualizations. Examples of information comprised in visualization data 270 include network topology visualizations that have been generated, active measure recommendations, visualization criteria such as grouping criteria, highlighting criteria, scope criteria, visualization type, etc.

According to various embodiments, memory 220 comprises executing application data 275. Executing application data 275 comprises data obtained or used in connection with executing an application such as an application to determine or predict whether a certain sample corresponds to malicious traffic or benign traffic, an application to identify anomalies or security risks, etc. Other applications comprise any other appropriate applications (e.g., an index maintenance application, a communications application, a machine learning model application, an application for detecting suspicious input strings, suspicious files, an application for detecting suspicious or unparked domains, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

FIG. 3 is an example of a visualization definition user interface according to various embodiments. In the example shown, user interface 300 is configured and presented by the system to enable a user to request a network topology visualization. User interface 300 comprises selectable elements or input fields in which the user inputs user-defined criteria.

User interface 300 comprises one or more of a visualization name field 305, a visualization description field 310, a build scope field 315, a first grouping field 320, and a second grouping field 325. The user defines the visualization name in visualization name field 305 and the visualization description in visualization description field 310. The user defines/specifies the visualization criteria in build scope field 315. The user may specify a visualization type, a network scope to be visualized, a set of network assets to include in the network topology visualization, etc. For example, if the user is only interested in visualizing network assets within a particular subnet(s), the user includes the subnet identifier for the subnet of interest in build scope field 315. The user uses first grouping field 320 to define a primary grouping criteria and second grouping field 325 to define the secondary grouping criteria.

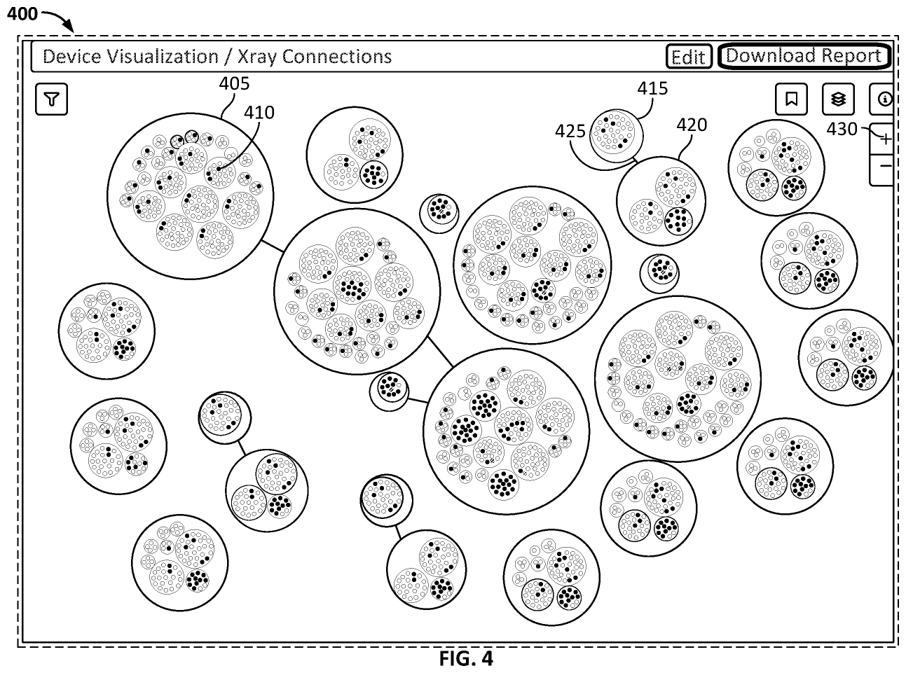

FIG. 4 is an example of a network topology visualization according to various embodiments. In the example shown, network topology visualization 400 is configured in a bubble map view. Each of the dots correspond to network assets, such as network asset 410. Each of the circles correspond to a particular grouping, such as group 405, group 415, and group 420. Lines connecting two groupings corresponds to a communication link (e.g., indicating that the corresponding groups are communicating with one another), for example, communication link 425 illustrating that one or more network assets within group 415 communicate with one or more network assets within group 420. Some network assets, such as network asset 410 are presented as bolded (e.g., a brighter icon is used to signify the network asset) or color coded. The bolding or coloring of the network asset elements may be defined (e.g., user-defined, such as during the specification of the visualization criteria) based on a highlighting criteria. User interface 430 further comprises zoom control with which a user can zoom-in or zoom-out according to the granularity of interest. For example, if the user zooms-in to the network topology visualization more detailed information pertaining to the groups or network assets may be provided. As the user continues to further zoom-in, different or more detailed information is provided (e.g., for the network assets or groups within view).

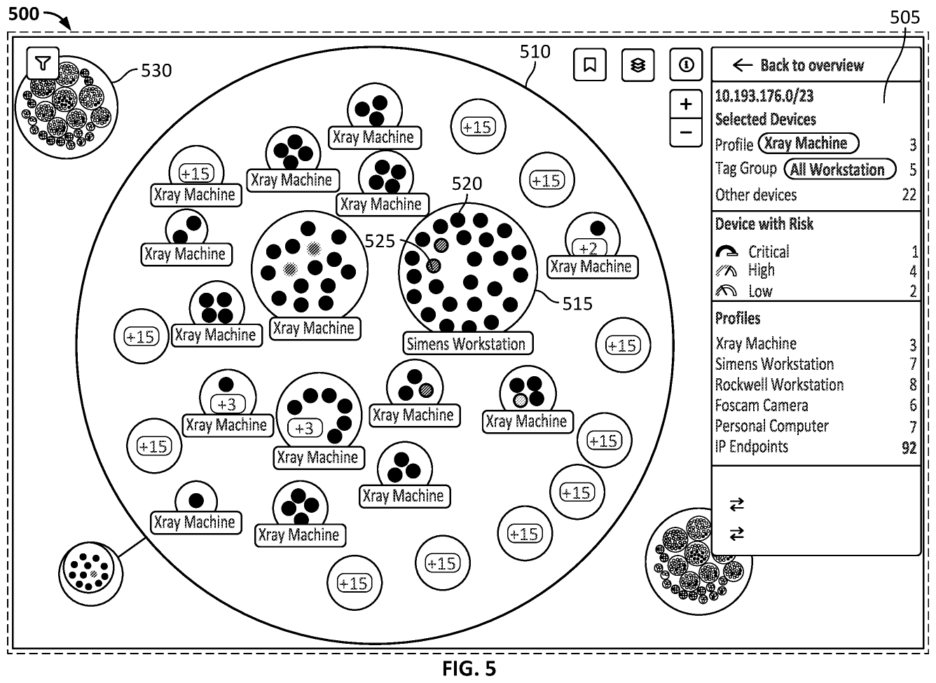

FIG. 5 is an example of a network topology visualization according to various embodiments. In the example shown, network topology visualization 500 is configured in a bubble map view. Network topology visualization 500 includes visualization detail element 505, which provides an indication of one or more of (i) the visualization criteria, (ii) security risk information (e.g., a number of security risks, or a number of security risks by security level), (iii) network asset information, such as a number of network assets by type (e.g., x-ray machine, workstation, camera, personal computers, endpoints, etc.). Network topology visualization 500 is an example of a zoomed-in perspective of the network topology. For example, the user has zoomed-in to the area of the network topology for group 510. Group 510 is more prominently displayed (e.g., more emphatically displayed) than non-selected or other groups outside the zoomed-in field of view, such as group 530. Because network topology visualization 500 is a zoomed-in view of group 510 granular information pertaining to group 510 is provided. For example, network topology visualization 500 displays network assets within each sub group, such as subgroup 515. The display of the various network assets may be according to a highlight criteria. For example, network asset 520 and network asset 525 may be color coded. Network asset 520 may be provided in blue signifying that no security threat/risk is identified for network asset 520. Conversely, network asset 525 may be provided in red, signifying that a security threat/risk (e.g., a critical security risk) is identified for network asset 525. Various other color-coding schemes may be implemented, including use of different colors to signify different levels of security risk or different security risk types.

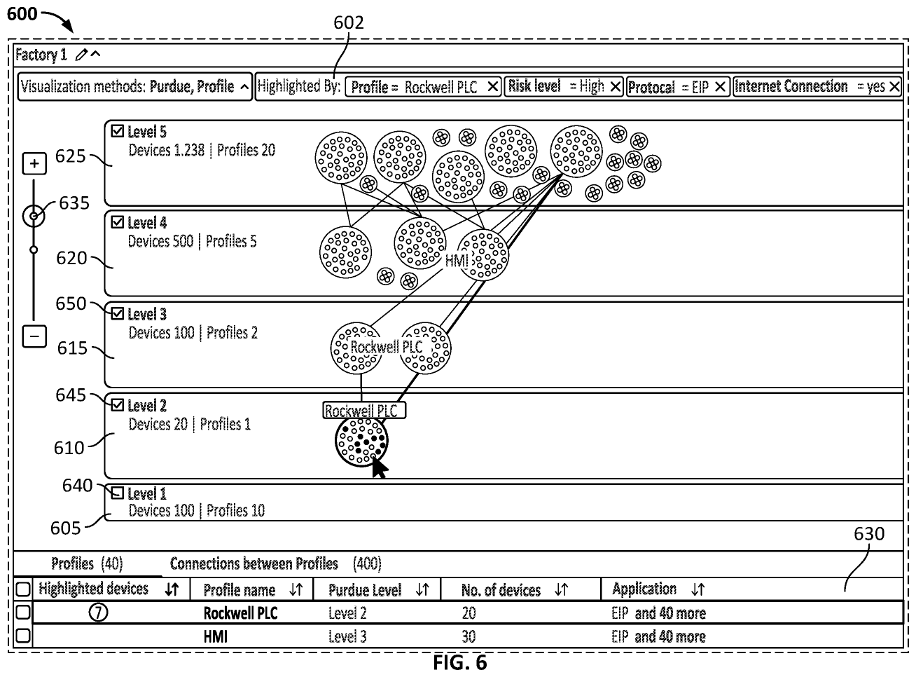

FIG. 6 is an example of a network topology visualization according to various embodiments. In the example shown, network topology visualization 600 is a Purdue model visualization (e.g., devices in the scope are first grouped by Purdue level as a primary grouping, and then a secondary grouping, if selected). Network topology visualization 600 comprises visualization criteria field 602 in which the user defines the visualization criteria. The user can dynamically update the visualization criteria, which may result in an updated rendering of the network topology visualization according to the updated visualization criteria. Network topology visualization 600 groups network assets into five groups level 1 group 605, level 2 group 610, level 3 group 615, level 4 group 620, and level 5 group 625. Each of the groups 605-625 may include sub-groupings of network assets within the respective groups. As shown, network topology visualization 600 comprises a detailed device information frame 630, which is shown to include information pertaining to various groups of network assets. The user can use zoom control 635 to zoom-in and zoom-out with respect to the network topology, to change the granularity of information presented for groups or network assets. For each of groups 605-625 network topology visualization 600 includes a selectable element, such as selectable element 640 for group 605, selectable element 645 for group 610, and selectable element 650 for group 615. In the example shown, selectable elements 645 and 650 are selected and selectable element 640 is not selected. Because selectable element 640 is not selected, the frame comprising group 605 provides summary information for network assets within the group, such as the number of devices or profiles. Groups 610-625 are provided in an expanded view because the corresponding selectable elements are selected. In the expanded group view, network topology visualization 600 provides more detailed information for the selected groups, such as a visualization of groupings and connections, etc.

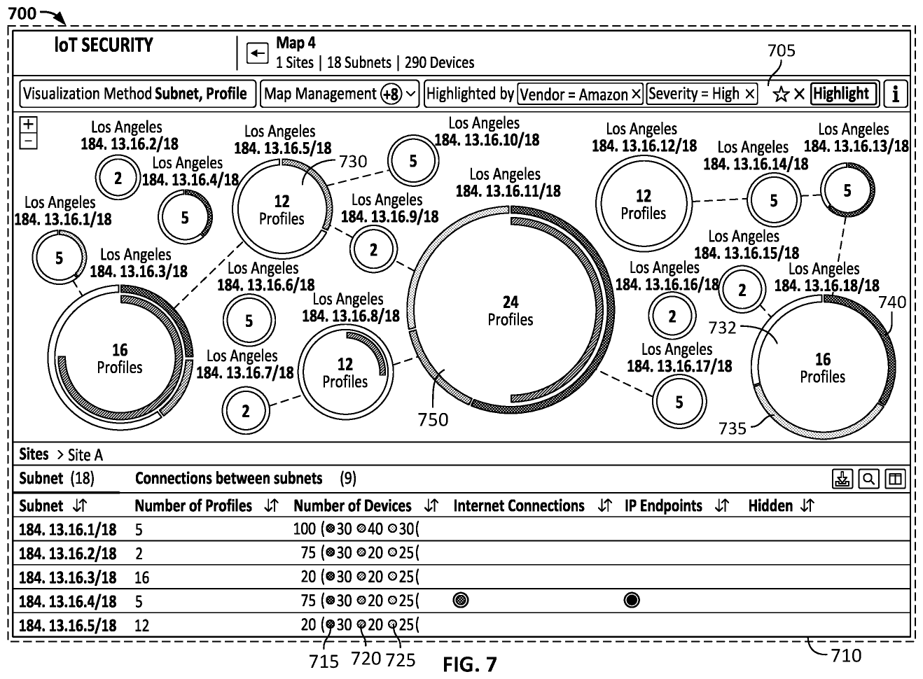

FIG. 7 is an example of a network topology visualization according to various embodiments. In the example shown, network topology visualization 700 provides a visualization for network assets within Los Angeles. The highlighting criteria is defined in highlight criteria field 705, which in this example indicates that the highlighting is on the basis of the vendor being Amazon and the security risk level/severity being high. Detailed information frame 710 comprises detailed information for devices within the various subnets. For example, with respect to subnet 184.13.16.5/18 corresponding to group 730, detailed information frame 710 includes an indication of the number of devices with corresponding indications of number of devices per security risk level. In the example shown, element 715 may be displayed in red so as to indicate that the corresponding subnet has 30 devices for which the security risk is high/critical; element 720 may be displayed in orange so as to indicate that the corresponding subnet has 20 devices for which the security risk is medium; and element 725 may be displayed in yellow so as to indicate that the subnet comprises 25 devices for which the security risk is low. Various other color coding or emphatic display may be implemented. Network topology visualization 700 may include an indication of the relative number of devices corresponding to different security risk levels. For example, group 732 comprises a first ring section 735 is color coded which is color coded as yellow to indicate a number/percentage of devices within group 732 for which the security risk is medium; and a second ring section 740, which is color coded as red to indicate a number/percentage of devices within group 732 for which the security risk is high/critical. The various groupings may be visualized having a plurality of rings, such as group 750 which comprises an outer ring providing an indication of the percentage or relative number of devices within the group having different security risk levels and an inner ring indicating a percentage or relative number of devices for which the vendor is Amazon.

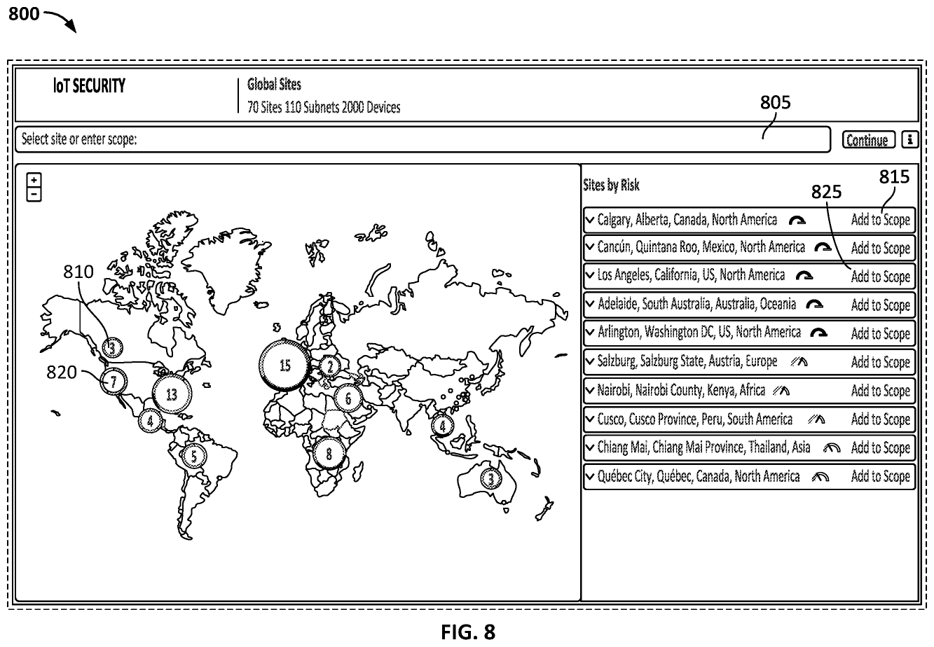

FIG. 8 is an example of a network topology visualization according to various embodiments. In the example shown, network topology visualization 800 provides a visualization of devices across the various global sites. The user may use this visualization to select sites to add to the scope of the network topology visualization to be generated. For example, the user may select to add the site for Calgary, Alberta 810 by selecting element 815, and/or select to add the site for Los Angeles 820 by selecting element 825. Alternatively, the user may define the scope in scope field 805 in which the user inputs the sites to be selected or other visualization criteria.

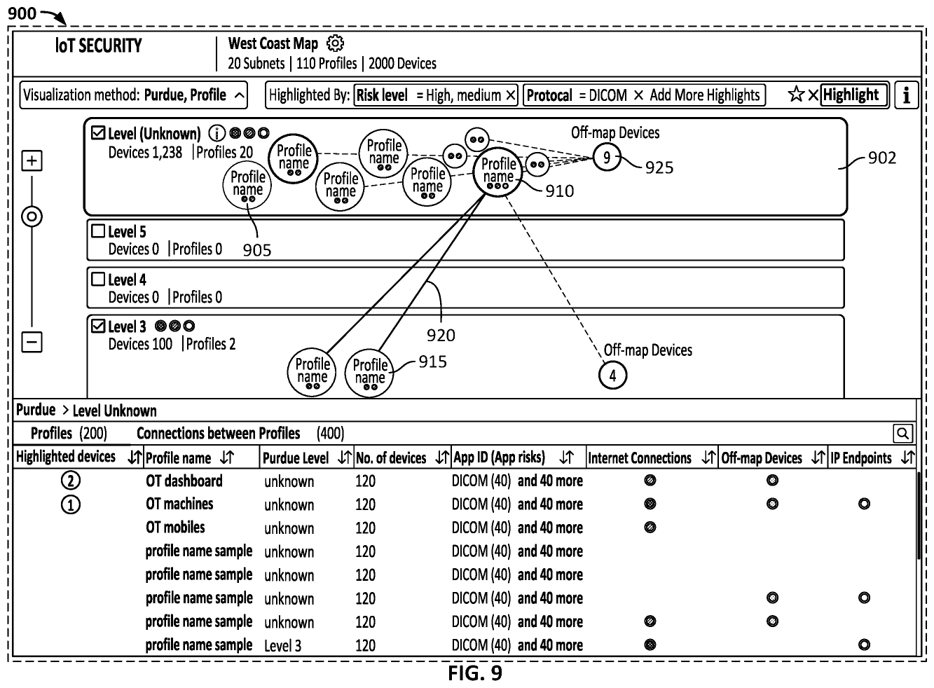

FIG. 9 is an example of a network topology visualization according to various embodiments. In the example shown, network topology visualization 900 visualizes the network assets as being grouped according to the Purdue level and a secondary grouping according to profile (e.g., the user identifier associated with the device). In the example shown, level grouping 902 comprises a plurality of subgroups according to profile, such as profile group 905 and profile group 910. As illustrated, network topology visualization 900 can be used to identify how different network assets or network assets for a particular profile communicate with other network assets. Profile group 910 comprises network assets that communicate with profile group 915 in the level 3 Purdue group, as denoted by communication link 920. Network topology visualization 900 may also be used to illustrate off-map devices 925 that are in communication with on-map devices, such as network assets within profile group 910.

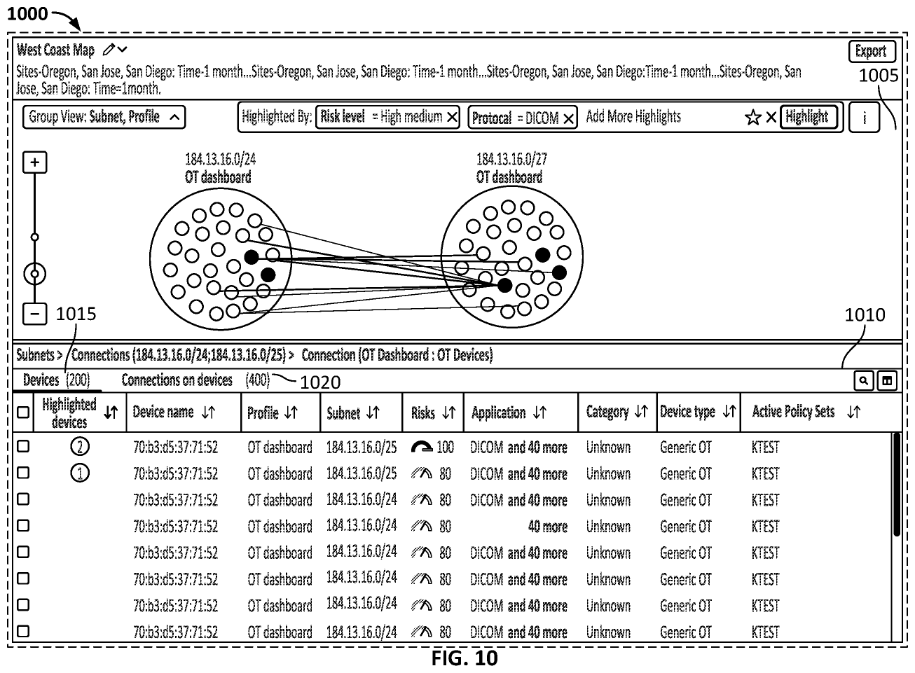

FIG. 10 is an example of a network topology visualization according to various embodiments. In the example shown, network topology visualization 1000 groups devices according to subnet as a primary group criteria and profile as a secondary group criteria. The groupings and interconnections are shown in frame 1005. The visualization/mapping shows only 2 main subnet bubbles with all profiles and devices, and shows connections between devices. Network topology visualization 1000 further comprises detailed device information frame 1010. Detailed device information frame 1010 includes a device tab 1015 and a connections on devices tab 1020, which can be selected to toggle the detailed information presented in detailed device information frame 1010. In response to device tab 1015 being selected, a device table is presented that provides information for all devices on both devices, including device name, profile, subnet, number of security risks, applications installed/running on the device, device category, device type, and policy configurations. In response to connections on devices tab 1020 being selected, a connection table is presented including information pertaining to connections for each device in the groups.

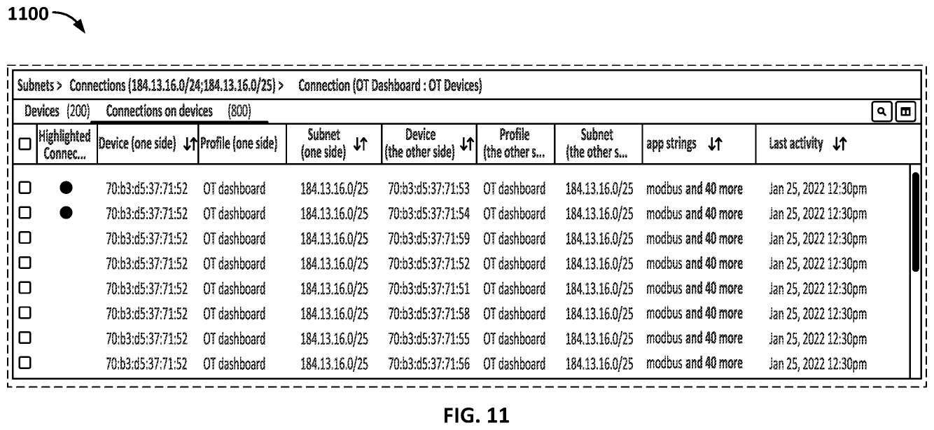

FIG. 11 is an example of a network topology visualization according to various embodiments. In the example shown, network topology visualization 1100 includes a connections table shown in a detailed device information frame of the visualization. For example, the connections table corresponds to the information presented in response to connections on devices tab 1020 of network topology visualization 1000 of FIG. 10. The connections table identifies highlighted connections (according to a highlighting criteria, etc.), a first device identifier, a profile for the first device, a subnet for the first device, a second device identifier on the other end of the connection with the first device, a profile for the second device, a subnet for the second device, etc.

FIG. 12 is a flow diagram of a method for providing a network topology visualization for a data abstraction according to various embodiments. In some embodiments, system 100 of FIG. 1 and/or system 200 of FIG. 2 implements process 1200.

At 1205, a criteria scope is obtained. The criteria scope may be user defined, such as via a user interface. The criteria scope identifies the scope of the network assets to be visualized, for example, selection of one or more sites of devices (e.g., all devices within Los Angeles, all devices within a particular subnet, etc.). At 1210, a grouping criteria is obtained. The user specifies a multi-level grouping, including a user-defined primary grouping, and a user-defined secondary grouping according to which the network assets are to be grouped. At 1215, a visualization type is obtained. For example, the user specifies the type of visualization according to which the network topology is to be presented, such as a bubble map, etc. At 1220, a network topology visualization is generated. The system generates the network topology visualization based at least in part on the network topology and the visualization criteria (e.g., the criteria scope, grouping criteria, visualization type, highlighting criteria, etc.). At 1225, a network topology visualization is provided. The system presents the network topology visualization, such as by configuring a user interface to be presented at a client system requesting the visualization. At 1230, a determination is made as to whether process 1200 is complete. In some embodiments, process 1200 is determined to be complete in response to a determination that no further network topology visualizations are to be generated, no further queries are received for network topology visualizations, an administrator indicates that process 1200 is to be paused or stopped, etc. In response to a determination that process 1200 is complete, process 1200 ends. In response to a determination that process 1200 is not complete, process 1200 returns to 1205.

FIG. 13 is a flow diagram of a method for generating a network topology visualization according to various embodiments. In some embodiments, system 100 of FIG. 1 and/or system 200 of FIG. 2 implements process 1300. Process 1300 may be invoked by process 1200, such as at 1220.

At 1305, the system obtains information pertaining to network assets for a network. The system may obtain the information pertaining to the network assets based at least in part on performing a device discovery process. For example, the system obtains network logs and/or supplemental information, which is then analyzed to obtain device metadata, etc. At 1310, the system determines a network topology. In some embodiments, the system determines the network topology based at least in part on the information pertaining to the network assets for the network. At 1315, the system generates the network topology visualization. In some embodiments, the system generates the network topology visualization based at least in part on the network topology and the visualization parameters (e.g., the parameters based on the user-definition for the visualization). At 1320, a determination is made as to whether process 1300 is complete. In some embodiments, process 1300 is determined to be complete in response to a determination that no further network topology visualizations are to be generated, no further queries are received for network topology visualizations, an administrator indicates that process 1300 is to be paused or stopped, etc. In response to a determination that process 1300 is complete, process 1300 ends. In response to a determination that process 1300 is not complete, process 1300 returns to 1305.

FIG. 14 is a flow diagram of a method for updating a network topology visualization according to various embodiments. In some embodiments, system 100 of FIG. 1 and/or system 200 of FIG. 2 implements process 1400. Process 1400 may be invoked by process 1200, such as at 1225.

At 1405, the system provides the network topology visualization. At 1410, the system receives a user input. Examples of user input include a zoom control input to zoom-in or zoom-out to different layers of information, or a selection input in which a user selects a particular group, a particular network asset, or a particular connection. At 1415, the system updates the network topology visualization based at least in part on the user input. For example, in response to determining that the user input is a zoom control to zoom-in, the system generates a zoom-in view comprising different information pertaining to the network topology (e.g., the groups or network assets). At 1420, the system provides the updated network topology visualization. At 1425, a determination is made as to whether process 1400 is complete. In some embodiments, process 1400 is determined to be complete in response to a determination that no further network topology visualizations are to be generated, no further queries are received for network topology visualizations, an administrator indicates that process 1400 is to be paused or stopped, etc. In response to a determination that process 1400 is complete, process 1400 ends. In response to a determination that process 1400 is not complete, process 1400 returns to 1405.

FIG. 15 is a flow diagram of a method for identifying security risks in a network topology according to various embodiments. In some embodiments, system 100 of FIG. 1 and/or system 200 of FIG. 2 implements process 1500. Process 1500 may be invoked by process 1200, such as at 1225.

At 1505, the system obtains the network topology. At 1510, the system selects a network asset in the network associated with the network topology. At 1515, the system determines whether the selected network asset is a security risk. In response to determining that the selected network asset is a security risk, process 1500 proceeds to 1520. Conversely, in response to determining that the selected network asset is not a security risk, process 1500 proceeds to 1535. At 1520, the system determines a type of security risk(s) associated with the selected network asset. At 1525, the system determines an active measure to perform with respect to the selected network. The system determines the active measure for remediating the security risk associated with the selected network asset. At 1530, the system provides an active measure recommendation. The active measure recommendation is determined based at least in part on the active measure to be performed. At 1535, the system determines whether another network asset is to be evaluated. In response to determining that another network asset is to be evaluated, process 1500 returns to 1510 and process 1500 iterates over 1510-1535 until no further network assets are to be evaluated. In response to determining that no other network asset is to be evaluated, process 1500 proceeds to 1540. At 1540, a determination is made as to whether process 1500 is complete. In some embodiments, process 1500 is determined to be complete in response to a determination that no further network topology visualizations are to be generated, no further queries are received for network topology visualizations, no further network assets are to be evaluated, an administrator indicates that process 1500 is to be paused or stopped, etc. In response to a determination that process 1500 is complete, process 1500 ends. In response to a determination that process 1500 is not complete, process 1500 returns to 1505.

FIG. 16 is a flow diagram of a method for identifying security risks in a network topology according to various embodiments. In some embodiments, system 100 of FIG. 1 and/or system 200 of FIG. 2 implements process 1600. Process 1600 may be invoked by process 1200, such as at 1225.

At 1605, the system obtains the network topology. At 1610, the system selects a network asset in the network associated with the network topology. At 1615, the system determines whether the selected network asset is a security risk. In response to determining that the selected network asset is a security risk, process 1600 proceeds to 1620. Conversely, in response to determining that the selected network asset is not a security risk, process 1600 proceeds to 1635. At 1620, the system determines a security risk(s) associated with the selected network asset. At 1625, the system updates the network topology visualization to include an indication(s) of the security risk(s) associated with the network asset. At 1630, the system provides an updated network topology visualization. For example, the system emphatically displays network assets for which a security risk is identified or a security risk for a particular security risk level is identified, etc. At 1635, the system determines whether another network asset is to be evaluated. In response to determining that another network asset is to be evaluated, process 1600 returns to 1610 and process 1600 iterates over 1610-1635 until no further network assets are to be evaluated. In response to determining that no other network asset is to be evaluated, process 1600 proceeds to 1640. At 1640, a determination is made as to whether process 1600 is complete. In some embodiments, process 1600 is determined to be complete in response to a determination that no further network topology visualizations are to be generated, no further queries are received for network topology visualizations, no further network assets are to be evaluated, an administrator indicates that process 1600 is to be paused or stopped, etc. In response to a determination that process 1600 is complete, process 1600 ends. In response to a determination that process 1600 is not complete, process 1600 returns to 1605.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for visualizing network topology, comprising:
one or more processors configured to:
automatically generate a network topology visualization of network assets for a network; and
group the network assets into a plurality of groupings based on a set of user selected distinct criteria; and
a memory coupled to the one or more processors and configured to provide the one or more processors with instructions.

2. The system of claim 1, wherein the network is an enterprise network.

3. The system of claim 1, wherein the network is an industrial network.

4. The system of claim 1, wherein the one or more processors are further configured to:
determine a potential security risk with the network based at least in part on one or more of the plurality of groupings.

5. The system of claim 4, wherein the one or more processors are further configured to:
in response to detecting the potential security risk, provide a recommendation for an active measure to be performed to remediate the potential security risk.

6. The system of claim 5, wherein the recommendation for the active measure is automatically generated based on threat research.

7. The system of claim 5, wherein the active measure includes one or more of: (i) install a patch on a particular network asset, (ii) invoke a password change for the particular network asset, (iii) cause a network configuration change to close a particular port, (iv) generate and provide an alert to a user associated with the network asset.

8. The system of claim 1, wherein the one or more processors are further configured to:
update the network topology visualization of network assets based at least in part on one or more of the plurality of groupings.

9. The system of claim 8, wherein the network topology visualization of network assets is updated to identify a subset of devices that satisfy a selected interest criteria.

10. The system of claim 9, wherein the subset of devices is identified based on causing the subset of network assets to be visualized more emphatically than other network assets for the network.

11. The system of claim 8, wherein the network topology visualization of network assets is updated to comprise a set of visualization indicators based on risks associated with one or more of the network assets for the network.

12. The system of claim 1, wherein the network assets are grouped according to at least two or more of: a network segmentation, a subnet, a device type, and a vendor.

13. The system of claim 1, wherein the network assets comprise one or more of a network device, an Internet of Things (IoT) device, and a commercial operational technology (OT) device.

14. The system of claim 1, wherein the one or more processors are further configured to receive a user input associated with the network topology visualization.

15. The system of claim 14, wherein the one or more processors are further configured to:
in response to determining that the user input is a zoom in request, updating the network visualization to include different information pertaining to one or more of the network assets.

16. The system of claim 15, wherein the different information comprises more granular detailed information for the network assets.

17. The system of claim 14, wherein the one or more processors are further configured to:
in response to determining that the user input corresponds to a selection of a particular network asset, configuring a user interface to include detailed information for the particular network asset.

18. The system of claim 17, wherein the detailed information comprises information pertaining to communications to/from the particular network asset.

19. The system of claim 14, wherein the one or more processors are further configured to:
in response to determining that the user input corresponds to a selection of a particular network asset, configuring a user interface to with which a user updates a configuration of the network asset in response to receipt of another user input.

20. A method for visualizing network topology, comprising:
automatically generating, by one or more processors, a network topology visualization of network assets for a network; and
grouping the network assets into a plurality of groupings based on a set of user selected distinct criteria.

21. A computer program product embodied in a non-transitory computer readable medium for visualizing network topology, and the computer program product comprising computer instructions for:
automatically generating, by one or more processors, a network topology visualization of network assets for a network; and
grouping the network assets into a plurality of groupings based on a set of user selected distinct criteria.
